(19) United States
(12) Patent Application Publication
(10) Pub. No.: US 2008/0239262 A1
(43) Pub. Date: Oct. 2, 2008

(54) Radiation source for generating electromagnetic radiation and method for generating electromagnetic radiation

(75) Inventor: Maarten Marinus Johannes Wilhelmus Van Herpen, Heesch (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/730,187

(22) Filed: Mar. 29, 2007

(51) Int. Cl. H01J 1/12; H01J 1/42; H01J 1/44; H01J 7/06

(52) U.S. Cl. 355/45; 313/11; 313/35; 355/44; 355/67; 378/141

(57) ABSTRACT

A radiation source for generating electromagnetic radiation includes an anode, a cathode, and a discharge space. The anode and the cathode are configured to create a discharge in a substance in the discharge space to form a plasma so as to generate the electromagnetic radiation. The radiation source also includes a fuel supply constructed and arranged to supply at least a component of the substance to a location near the discharge space. The fuel supply is located at a distance from the anode and the cathode. The radiation source also includes a further supply constructed and arranged to create and/or maintain a cooling and/or protective layer on or near the anode and/or cathode.

### FIELD

The present invention generally relates to a radiation source for generating electromagnetic radiation, such as extreme ultraviolet radiation.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In a lithographic apparatus, the size of features that can be imaged onto the wafer may be somewhat limited by the wavelength of the projection radiation. To produce integrated circuits with a higher density of devices, and hence higher operating speeds, it is desirable to be able to image smaller features. While most current lithographic apparatus employ ultraviolet light generated by mercury lamps or excimer lasers, it has been proposed to use shorter wavelength radiation of around 13 nm. Such radiation is termed extreme ultraviolet, also referred to as XUV or EUV, radiation. The abbreviation ‘XUV’ generally refers to the wavelength range from several tenths of a nanometer to several tens of nanometers, combining the soft x-ray and vacuum UV range, whereas the term ‘EUV’ is normally used in conjunction with lithography (EUVL) and refers to a radiation band from approximately 5 to 20 nm, i.e. part of the XUV range.

A radiation source for XUV radiation may be a discharge plasma radiation source, in which a plasma is generated by a discharge in a substance (for instance, a gas or vapor) between an anode and a cathode, and in which a high temperature discharge plasma may be created by Ohmic heating by a (pulsed) current flowing through the plasma. Compression of a plasma due to a magnetic field generated by a current flowing through the plasma may be used to create a high temperature, high density plasma on a discharge axis (pinch effect). Stored electrical energy is directly transferred to the plasma temperature and hence to short-wavelength radiation. A pinch may allow for a plasma having a considerably higher temperature and density on the discharge axis, thereby offering an extremely large conversion efficiency of stored electrical energy into thermal plasma energy and thus into XUV radiation. The construction and operation of plasma discharge devices, such as plasma focus, Z-pinch, hollow-cathode and capillary discharge sources, may vary, but in almost each of these types, a magnetic field generated by the electrical current of the discharge drives the compression.

The high rate with which the stored electrical energy is transferred to the plasma temperature may give rise to a very high heat-load on the anode and the cathode. This may cause the anode and/or cathode to deform or even melt, which may inconveniently limit the maximum power of the radiation source.

The substance may be supplied in liquid form using the anode and the cathode. The anode and/or the cathode may be rotatably mounted on a frame of the source and partially dipped in a reservoir comprising a liquid metal, such as Sn. A laser is used to evaporate the liquid from the surface of the anode or the cathode. The part of the anode and/or cathode which is dipped in the bath may be suitably cooled by the reservoir, thereby reducing the vulnerability of the anode and/or cathode to the heat load caused by the temperature of the plasma.

A disadvantage of such a radiation source is that the repetition frequency of the discharge may be limited by the rotation speed of the wheels, because the laser-evaporated Sn has to be replaced by Sn from the reservoir or from another form of Sn supply.

### SUMMARY

According to an aspect of the invention, a radiation source for generating electromagnetic radiation is provided. The radiation source includes an anode, a cathode, and a discharge space. The anode and the cathode are configured to create a discharge in a substance in the discharge space to form a plasma so as to generate the electromagnetic radiation. The radiation source also includes a fuel supply constructed and arranged to supply at least a component of the substance to a location near the discharge space. The fuel supply is located at a distance from the anode and the cathode. The radiation source also includes a further supply constructed and arranged to create and/or maintain a cooling and/or protective layer on or near the anode and/or cathode.

According to an aspect of the invention, there is provided a module for a lithographic apparatus. The module includes a radiation source constructed and arranged to generate electromagnetic radiation. The radiation source includes an anode, a cathode, and a discharge space. The anode and the cathode being configured to create a discharge in a substance in the discharge space to form a plasma so as to generate the electromagnetic radiation. The radiation source also includes a fuel supply constructed and arranged to supply at least a component of the substance to a location near the discharge space. The fuel supply is located at a distance from the anode and the cathode. The radiation source also includes a further supply constructed and arranged to create and/or maintain a cooling and/or protective layer on or near the anode and/or cathode. The module also includes a collector constructed and arranged to focus the electromagnetic radiation in a focal point.

According to an aspect of the inventions, there is provided a lithographic apparatus that includes a radiation source constructed and arranged to generate electromagnetic radiation. The radiation source includes an anode, a cathode, and a discharge space. The anode and the cathode are configured to create a discharge in a substance in the discharge space to form a plasma so as to generate the electromagnetic radiation. The radiation source also includes a fuel supply constructed and arranged to supply at least a component of the substance to a location near the discharge space. The fuel supply is located at a distance from the anode and the cathode. The radiation source also includes a further supply constructed and arranged to create and/or maintain a cooling and/or protective layer on or near the anode and/or cathode. The lithographic apparatus also includes an illumination system configured to condition the electromagnetic radiation, and a support constructed to support a patterning device. The patterning device is constructed and arranged to impart the conditioned electromagnetic radiation with a pattern in its cross-section to form a patterned radiation beam. The apparatus also includes a substrate table constructed to hold a substrate, and a projection system configured to project the patterned radiation beam onto a target portion of the substrate.

According to an aspect of the invention, there is provided a method for generating electromagnetic radiation. The method includes supplying at least a component of a substance to a location near a discharge space between an anode and a cathode and at a distance from the anode and the cathode, creating a discharge between the anode and the cathode in the substance to form a plasma, and creating and/or maintaining a cooling and/or protective layer on or near the anode and/or cathode during said supplying the substance and/or creating the discharge.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 is a schematic view of a lithographic apparatus according to an embodiment of the invention;

FIG. 2 is a schematic view of an embodiment of a radiation source of FIG. 1;

FIG. 3 is a schematic view of a supply for creating and/or maintaining a cooling and/or protective layer on an anode and/or cathode of the radiation source;

FIG. 4 is a schematic view of another supply for creating and/or maintaining a cooling and/or protective layer on the anode and/or cathode; and

FIG. 5 is a schematic view of an embodiment of the radiation source of FIG. 1.

### DETAILED DESCRIPTION

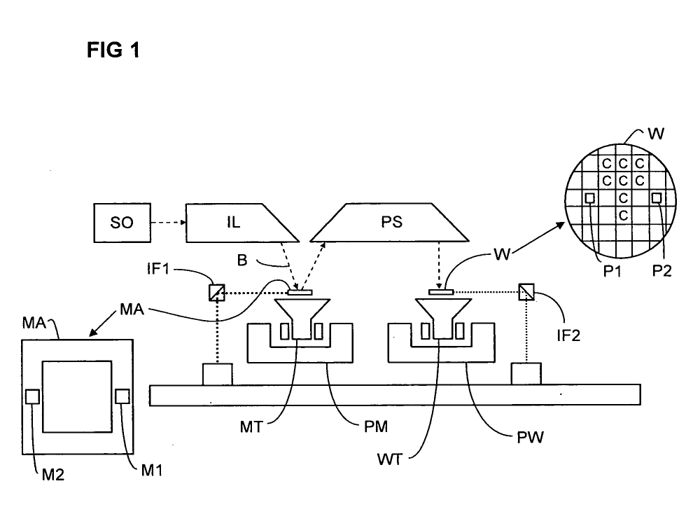

FIG. 1 schematically depicts a lithographic apparatus. The apparatus comprises: an illumination system (illuminator) IL configured to condition a radiation beam B (e.g. UV radiation or EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a reflective projection system) PS configured to project a pattern imparted to the radiation beam B by the patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including reflective, magnetic, electromagnetic and electrostatic optical systems, or any combination thereof, as appropriate for the exposure radiation being used.

As here depicted, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives a radiation beam B from a radiation source SO for generating electromagnetic radiation. The source SO and the lithographic apparatus may be separate entities. In such cases, the source is not considered to form part of the lithographic apparatus and the radiation beam is passed from the source SO to the illuminator IL with the aid of a beam delivery system comprising, for example, suitable directing mirrors and/or a beam expander. Also, the source may be comprised in a module which further comprises a collector CO which is arranged to focus electromagnetic radiation generated by the source in a focal point. Such a module may commonly be referred to as the source-collector module. The source SO and the illuminator IL, together with the beam delivery system if needed, may be referred to as a radiation system.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

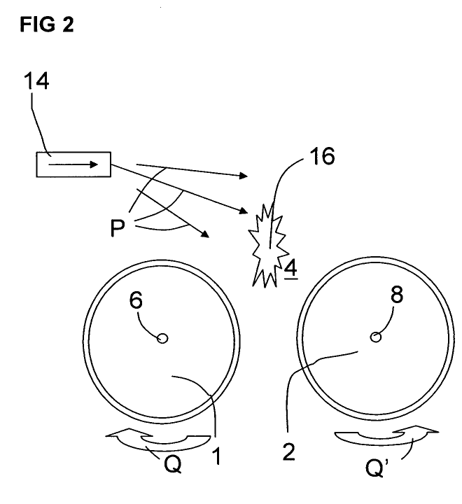

FIG. 2 is a schematic view of an embodiment of the radiation source SO according to the invention. The radiation source SO comprises an anode 1, a cathode 2 and a discharge space 4 which is located between the anode 1 and the cathode 2. The anode 1 and the cathode 2 may have a cylindrical shape and may each be rotatably mounted on respective shafts 6, 8 by which the anode 1 and the cathode 2 are driven when the radiation source SO is in operation, as represented by Q and Q′, respectively. The radiation source SO may be provided with a frame on which the shafts 6, 8 are mounted, but which frame, for the sake of clarity, has been omitted in the Figures.

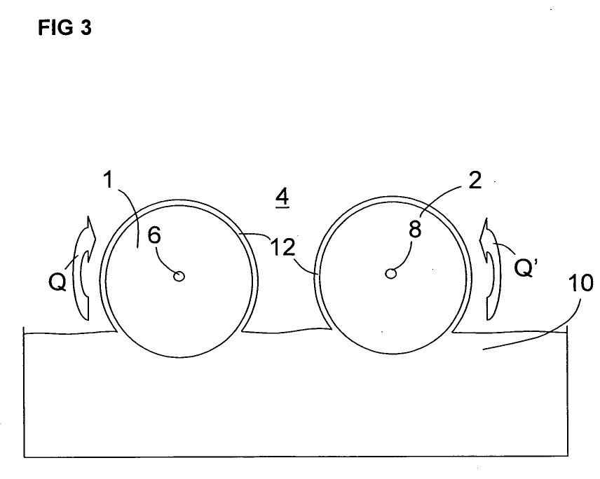

As shown in FIG. 3, the radiation source SO may comprise a supply 10 for supplying, creating, and/or maintaining a cooling and/or protective layer 12 on or near the anode 1 and/or cathode 2 for cooling and/or protecting the anode 1 and/or cathode 2. The layer 12 may be a surface layer. The supply 10 may be a reservoir 10 (see FIG. 3) containing liquid Sn in which the anode 1 and the cathode 2 are rotatably mounted.

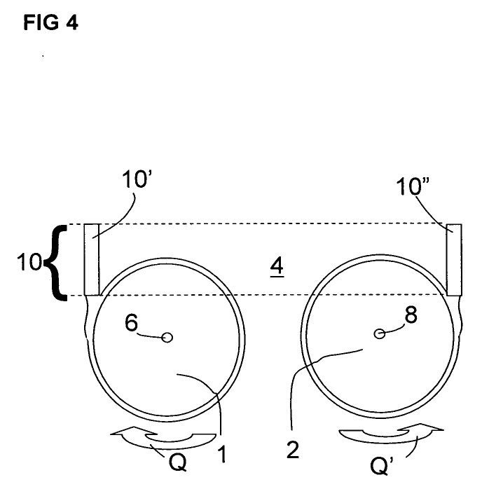

As shown in FIG. 4, the supply 10 may comprise outlets 10′, 10″ in the vicinity of the anode 1 and/or cathode 2, respectively. The outlets 10′, 10″ may be configured to feed the liquid directly to the anode 1 and/or the cathode 2, respectively, during rotation of the anode 1 and/or the cathode 2. The outlets 10′, 10″ may be configured for a user to set the flow rate of the liquid fed to the anode 1 and/or the cathode 2, so that the liquid forms the cooling and/or protective layer 12 for cooling and/or protecting the anode 1 and/or cathode 2. The layer 12 may be a surface layer.

The liquid Sn may be comprised in an alloy, such as an alloy that includes Ga and Sn, such as a GaInSn alloy, which may be supplied by the reservoir 10, the outlets 10′, 10″ or any other supply. Several of such alloys have a liquid state at room temperature and therefore do not need additional heating in order for the alloy to reach the liquid state.

Returning to FIG. 2, the radiation source SO also comprises a fuel supply 14 for supplying a substance P, such as SnH₄, to a location at least near the discharge space 4. The fuel supply 14 may also be mounted on the frame that supports the shafts 6, 8. Suitable alternatives of substances which may be supplied by the fuel supply 14 include, but are not limited to Li, Xe, Sn and Sn-halides, such as SnI₂ and SnCl₂.

In operation, the fuel supply 14 supplies the substance P to the location near the discharge space 4. In the discharge space 4, a pulsed current flows through the discharge space 4, each pulse creating a discharge plasma 16 in the discharge space 4. The current flowing through the plasma 16 generates a magnetic field which compresses the plasma. Compression of the plasma may cause a high temperature, high density plasma in the discharge space 4. Electrical energy is converted to the plasma temperature and to short-wavelength radiation, part of which has a wavelength of about 13 nm. While the radiation is generated, the anode 1 and the cathode 2 rotate. During rotation, the supply 10 feeds the liquid to different parts of the anode 1 and/or cathode 2, thereby cooling the anode 1 and/or the cathode 2 and maintaining the layer 12. Thus, the anode 1 and the cathode 2 may be consistently protected against operational damage caused by the pulsed current flowing through the discharge space 4. The discharge frequency is not limited by the rotation speed of the anode 1 and/or the cathode 2, because the anode and/or the cathode do not necessarily supply the fuel.

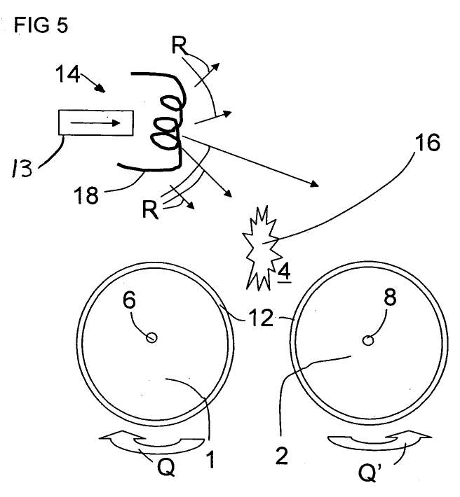

FIG. 5 is a schematic view of one embodiment of the radiation source SO. The embodiment of FIG. 5 is similar to the embodiment shown in FIG. 2. However, in the embodiment of FIG. 5, the fuel supply 14 includes a fuel source 13 and a radical generator 18 that is constructed and arranged to generate radicals R from fuel being supplied by the fuel source. For example, the fuel may be an H₂-containing gas, or hydrogen, and the generator 18 may be an atomic hydrogen generator. The generator 18 may be a hot filament located near the fuel supply 13 so that at least a part of the H₂ will be dissociated by the filament, thereby generating atomic hydrogen (H):

H₂→2H

Part of the atomic hydrogen may be directed to the anode 1 and/or the cathode 2, where it will react with the liquid Sn or with vapor Sn emerging from the anode and/or cathode to form SnH₄:

Sn+4H→SnH₄

In this embodiment, the fuel supply is constructed and arranged to supply a component of the substance to the discharge space, because in operation, the generated SnH₄ may fill at least a part of the discharge space 4 and a discharge may be produced between the anode 1 and the cathode 2.

It is also possible to use this method in combination with a further plate of solid Sn (not shown in the Figures) to generate SnH₄, which may be subsequently directed towards the anode 1 and cathode 2. In that case, the atomic hydrogen generator and the further plate of Sn form the fuel supply 14.

It is also possible to make a combination between the embodiments of FIGS. 2 and 5. For example, the atomic hydrogen may be fully or partly directed towards a further plate of solid Sn, where SnH₄ is generated. The SnH₄ and the remaining hydrogen atoms are subsequently directed towards the anode 1 and the cathode 2, where the hydrogen atoms may generate additional SnH₄.

The reservoir 10 of FIG. 3 may be used to supply, create and maintain the layer 12 on the anode 1 and/or cathode 2 of the embodiment of FIG. 5. One or more of the outlets 10′, 10″ of FIG. 4 may also be used with the embodiment of FIG. 5.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A radiation source for generating electromagnetic radiation, the radiation source comprising:
an anode;
a cathode;
a discharge space, the anode and the cathode being configured to create a discharge in a substance in the discharge space to form a plasma so as to generate the electromagnetic radiation;
a fuel supply constructed and arranged to supply at least a component of the substance to a location near the discharge space, the fuel supply being located at a distance from the anode and the cathode; and
a further supply constructed and arranged to create and/or maintain a cooling and/or protective layer on or near the anode and/or cathode.

2. A radiation source according to claim 1, wherein the substance comprises Xe, Sn, Sn-halide, and/or SnH₄.

3. A radiation source according to claim 2, wherein the Sn-halide comprises SnI₂ or SnCl₂.

4. A radiation source according to claim 1, wherein the component of the substance is hydrogen radicals.

5. A radiation source according to claim 1, wherein the cooling and/or protective layer is formed by a liquid.

6. A radiation source according to claim 1, wherein the cooling and/or protective layer is formed by a liquid metal.

7. A radiation source according to claim 1, wherein the liquid metal is an alloy comprising Sn.

8. A radiation source according to claim 7, wherein the alloy comprises Ga and Sn.

9. A radiation source according to claim 8, wherein the alloy is a GaInSn alloy.

10. A radiation source according to claim 1, wherein the layer is formed by Sn.

11. A radiation source according to claim 1, wherein the anode and/or cathode are rotatably mounted in the radiation source.

12. A radiation source according to claim 11, wherein the anode and/or cathode are rotatably mounted such that the further supply creates and/or maintains the layer during rotation of the anode and/or cathode.

13. A radiation source according to claim 1, wherein the fuel supply comprises a fuel source and a radical generator located near the fuel source, the radical generator being constructed and arranged to generate radicals from a fuel supplied by the fuel source.

14. A radiation source according to claim 13, wherein the fuel comprises a H₂-containing gas and the radicals are hydrogen radicals.

15. A radiation source according to claim 13, wherein the radical generator comprises a hot filament.

16. A radiation source according to claim 13, wherein the radicals are suitable to react with a coating on the anode and/or cathode to form the substance.

17. A radiation source according to claim 1, wherein the electromagnetic radiation is extreme ultraviolet radiation.

18. A radiation source according to claim 1, wherein the discharge space is located between the anode and the cathode.

19. A module for a lithographic apparatus, the module comprising
a radiation source constructed and arranged to generate electromagnetic radiation, the radiation source comprising
an anode;
a cathode;
a discharge space, the anode and the cathode being configured to create a discharge in a substance in the discharge space to form a plasma so as to generate the electromagnetic radiation;
a fuel supply constructed and arranged to supply at least a component of the substance to a location near the discharge space, the fuel supply being located at a distance from the anode and the cathode; and
a further supply constructed and arranged to create and/or maintain a cooling and/or protective layer on or near the anode and/or cathode; and
a collector constructed and arranged to focus the electromagnetic radiation in a focal point.

20. A module according to claim 19, wherein the collector comprises a shell-shaped mirror for focusing the electromagnetic radiation in the focal point.

21. A module according to claim 20, wherein the collector comprises a plurality of such shell-shaped mirrors arranged concentrically around an optical axis.

22. A lithographic apparatus comprising:
a radiation source constructed and arranged to generate electromagnetic radiation, the radiation source comprising
an anode;
a cathode;
a discharge space, the anode and the cathode being configured to create a discharge in a substance in the discharge space to form a plasma so as to generate the electromagnetic radiation;
a fuel supply constructed and arranged to supply at least a component of the substance to a location near the discharge space, the fuel supply being located at a distance from the anode and the cathode; and
a further supply constructed and arranged to create and/or maintain a cooling and/or protective layer on or near the anode and/or cathode;
an illumination system configured to condition the electromagnetic radiation;
a support constructed to support a patterning device, the patterning device being constructed and arranged to impart the conditioned electromagnetic radiation with a pattern in its cross-section to form a patterned radiation beam;
a substrate table constructed to hold a substrate; and
a projection system configured to project the patterned radiation beam onto a target portion of the substrate.

23. A lithographic apparatus according to claim 22, further comprising a collector constructed and arranged to focus the electromagnetic radiation in a focal point.

24. A lithographic apparatus according to claim 23, wherein the collector comprises a shell-shaped mirror for focusing the electromagnetic radiation in the focal point.

25. A method for generating electromagnetic radiation, the method comprising:
supplying at least a component of a substance to a location near a discharge space between an anode and a cathode and at a distance from the anode and the cathode;
creating a discharge between the anode and the cathode in the substance to form a plasma; and
creating and/or maintaining a cooling and/or protective layer on or near the anode and/or cathode during said supplying the substance and/or creating the discharge.

26. A method according to claim 25, wherein the substance comprises Xe, Sn, Sn-halide, and/or SnH₄.

27. A method according to claim 26, wherein the Sn-halide comprises such as SnI₂ or SnCl₂.

28. A method according to claim 25, wherein the component of the substance is hydrogen radicals.

29. A method according to claim 25, wherein the cooling and/or protective layer is formed by a liquid.

30. A method according to claim 25, wherein the cooling and/or protective layer is formed by a liquid metal.

31. A method according to claim 30, wherein the liquid metal is an alloy comprising Sn.

32. A method according to claim 31, wherein the alloy comprises Ga and Sn.

33. A method according to claim 32, wherein the alloy is a GaInSn alloy.

34. A method according to claim 25, wherein the cooling and/or protective layer is formed by Sn.

35. A method according to claim 25, further comprising generating radicals from a fuel.

36. A method according to claim 35, wherein the fuel comprises a H₂-containing gas. and the radicals are hydrogen radicals

37. A method according to claim 35, wherein the radicals react with a vapor emerging from the anode and/or cathode.

38. A method according to claim 37, wherein the vapor comprises Sn.
